(19) United States
(12) Patent Application Publication
(10) Pub. No.: US 2026/0274211 A1
(43) Pub. Date: Sep. 17, 2026

(54) NOZZLES FOR VEHICLE DRYING APPARATUS FOR CAR WASH FACILITY AND METHODS OF USE

(71) Applicant: Sonny's Enterprises, LLC, Tamarac, FL (US)

(72) Inventor: Todd T. Buckner, Tifton, GA (US)

(21) Appl. No.: 19/668,236

(22) Filed: May 5, 2026

Related U.S. Application Data
(63) Continuation of application No. 16/979,795, filed on Mar. 11, 2019.
(60) Provisional application No. 62/641,484, filed on Mar. 12, 2018.
(60) Provisional application No. 62/670,389, filed on May 11, 2018.
(60) Provisional application No. 62/728,467, filed on Sep. 7, 2018.

(51) Int. Cl. B60S 3/00; F26B 21/50

(52) U.S. Cl. CPC B60S 3/002; F26B 21/50

(57) ABSTRACT

The present invention is a drying system for a car wash facility. In various aspects, the drying apparatus according to the system may include a plurality of nozzles, with each nozzle emanating a jet of air that impacts an upper surface of a vehicle with the jets arranged to successively force water on the upper surface laterally with respect to a vehicle centerline toward sides of the vehicle. In various aspects, the methods of use of the drying apparatus may include the step of receiving a vehicle in the drying apparatus, and the step of successively forcing water on the upper surface of the vehicle laterally with respect to the vehicle centerline toward sides of the vehicle by impacting the upper surface of the vehicle with a plurality of jets of air emanating from a corresponding plurality of nozzles.

### CROSS-REFERENCE TO RELATED APPLICATIONS

This application is a continuation of U.S. patent application Ser. No. 16/979,795, filed Sep. 10, 2020, which is a national stage entry of International Patent Application No. PCT/US2019/021577, filed Mar. 11, 2019, which claims priority to U.S. Provisional Patent Application No. 62/641,484, filed Mar. 12, 2018, U.S. Provisional Patent Application No. 62/670,389, filed May 11, 2018, and U.S. Provisional Patent Application No. 62/728,467, filed Sep. 7, 2018, each of which is incorporated by reference herein, in the entirety and for all purposes.

### TECHNICAL FIELD

The present invention is directed to drying systems used in car wash facilities and, more particularly, to an improved forced air drying system for removing water from a vehicle.

### BACKGROUND ART

In various car wash facilities currently available, drying may be accomplished with drying devices that include blowers that blow air onto the vehicle generally from vehicle front to vehicle back drying the vehicle partly by evaporation and partly by blowing water off of the vehicle generally rearward. However, current drying devices may dry the vehicle incompletely, may leave streaks or spots on the vehicle, and may leave dirt or chemical debris on the vehicle.

Accordingly, there is a need for improved drying apparatus for drying a vehicle as well as related processes for drying the vehicle using the drying apparatus.

### DISCLOSURE OF THE INVENTION

These and other needs and disadvantages may be overcome by the apparatus and related methods of use disclosed herein. Additional improvements and advantages may be recognized by those of ordinary skill in the art upon study of the present disclosure.

A drying apparatus is disclosed herein. In various aspects, the drying apparatus may include a plurality of nozzles. Each nozzle of the plurality of nozzles emanates a jet of air that impacts an upper surface of a vehicle with the jets arranged to successively force water on the upper surface at least in part laterally with respect to a vehicle centerline toward sides of the vehicle.

In various aspects, the methods of use of the drying apparatus may include the step of receiving a vehicle in the drying apparatus, and the step of successively forcing water on the upper surface of the vehicle laterally at least in part with respect to the vehicle centerline toward sides of the vehicle by impacting the upper surface of the vehicle with a plurality of jets of air emanating from a corresponding plurality of nozzles.

This summary is presented to provide a basic understanding of some aspects of the apparatus and methods disclosed herein as a prelude to the detailed description that follows below. Accordingly, this summary is not intended to identify key elements of the apparatus and methods disclosed herein or to delineate the scope thereof.

### BRIEF DESCRIPTION OF THE DRAWINGS

FIG. 1A illustrates by process flow chart an exemplary dryer apparatus;

FIG. 1B illustrates by schematic diagram the exemplary dryer apparatus of FIG. 1A;

FIG. 2A illustrates by perspective view portions of the exemplary dryer apparatus of Figure IA;

FIG. 2B illustrates by side view portions of the exemplary dryer apparatus of FIG. 1A;

FIG. 2C illustrates diagrammatically portions of the exemplary dryer apparatus of FIG. 1A;

FIG. 3A illustrates by cut-away side view portions of the exemplary dryer apparatus of FIG. 1A;

FIG. 3B illustrates diagrammatically portions of the exemplary dryer apparatus of FIG. 1A;

FIG. 4 illustrates by perspective view portions of the exemplary dryer apparatus of FIG. 1A;

FIG. 5 illustrates diagrammatically portions of the exemplary dryer apparatus of FIG. 1A;

FIG. 6 illustrates diagrammatically portions of the exemplary dryer apparatus of FIG. 1A;

FIG. 7 illustrates schematically a second exemplary dryer apparatus;

FIG. 8 illustrates by perspective view portions of the second exemplary dryer apparatus of FIG. 7;

FIG. 9A illustrates by perspective view portions of the second exemplary dryer apparatus of FIG. 7;

FIG. 9B illustrates by top view portions of the second exemplary dryer apparatus of FIG. 7;

FIG. 10 illustrates by cut-away perspective view portions of the second exemplary dryer apparatus of FIG. 7;

FIG. 11 illustrates schematically a third exemplary dryer apparatus;

FIG. 12A illustrates by frontal elevation view portions of the third exemplary dryer apparatus of FIG. 11;

FIG. 12B illustrates by side elevation view portions of the third exemplary dryer apparatus of FIG. 11;

FIG. 12C illustrates by bottom plan view portions of the third exemplary dryer apparatus of FIG. 11;

FIG. 13A illustrates by frontal elevation view portions of the third exemplary dryer apparatus of FIG. 11;

FIG. 13B illustrates by side elevation view portions of the third exemplary dryer apparatus of FIG. 11;

FIG. 13C illustrates by bottom plan view portions of the third exemplary dryer apparatus of FIG. 11;

FIG. 14A illustrates by bottom view portions of the third exemplary dryer apparatus of FIG. 11;

FIG. 14B illustrates by side perspective view portions of the third exemplary dryer apparatus of FIG. 11;

FIG. 15A illustrates by side elevation view portions of a fourth exemplary dryer apparatus;

FIG. 15B illustrates by side perspective view portions of the fourth exemplary dryer apparatus of FIG. 15A; and,

FIG. 15C illustrates by bottom perspective view portions of the fourth exemplary dryer apparatus of FIG. 15A.

The Figures are exemplary only, and the implementations illustrated therein are selected to facilitate explanation. The number, position, relationship and dimensions of the elements shown in the Figures to form the various implementations described herein, as well as dimensions and dimensional proportions to conform to specific force, weight, strength, flow and similar requirements are explained herein or are understandable to a person of ordinary skill in the art upon study of this disclosure. Where used in the various Figures, the same numerals designate the same or similar elements. Furthermore, when the terms “top,” “bottom,” “right,” “left,” “forward,” “rear,” “first,” “second,” “inside,” “outside,” and similar terms are used, the terms should be understood in reference to the orientation of the implementations shown in the drawings and are utilized to facilitate description thereof. Use herein of relative terms such as generally, about, approximately, essentially, may be indicative of engineering, manufacturing, or scientific tolerances such as ±0.1%, ±1 %, ±2.5%, ±5%, or other such tolerances, as would be recognized by those of ordinary skill in the art upon study of this disclosure.

### DETAILED DESCRIPTION OF THE INVENTION

A drying apparatus that may form a portion of a car wash facility is disclosed herein. The car wash facility may be used to wash a vehicle such as, for example, a car, truck, or van. The drying apparatus may then be incorporated in the car wash facility to dry the vehicle following washing of the vehicle. The drying apparatus, as disclosed herein, includes a plurality of nozzles, in various aspects. Each nozzle of the plurality of nozzles emanates a jet of air that impacts an upper surface of the vehicle, in various aspects. The jets are arranged to successively force water on the upper surface at least in part laterally with respect to a vehicle centerline of the vehicle toward sides of the vehicle, in various aspects. The jets may successively impact distinct regions of the upper surface to force water on the upper surface at least in part laterally with respect to a vehicle centerline of the vehicle toward sides of the vehicle, in various aspects. The vehicle may be traversed past the nozzles with the nozzles being stationary, or the nozzles may be traversed past the vehicle with the vehicle being stationary, in various aspects. The drying apparatus may include nozzles oriented to impact side surfaces of the vehicle to remove water from the sides including water forced onto the side surfaces from the upper surface. Various jets may be oriented to impact the upper surface or the side surface at acute angles in order to facilitate forcing of the water from the surface, in various aspects. A particular nozzle may be formed to introduce swirl into the jet, in various aspects. A particular nozzle may be formed to emanate a jet having a V-shape, in various aspects.

Methods of drying a vehicle using the drying apparatus are disclosed herein. In various aspects, the methods may include the step of receiving a vehicle in cooperation with the drying apparatus, and the step of successively forcing water on the upper surface of the vehicle laterally at least in part with respect to the vehicle centerline toward sides of the vehicle by impacting the upper surface of the vehicle with a plurality of jets of air emanating from a corresponding plurality of nozzles.

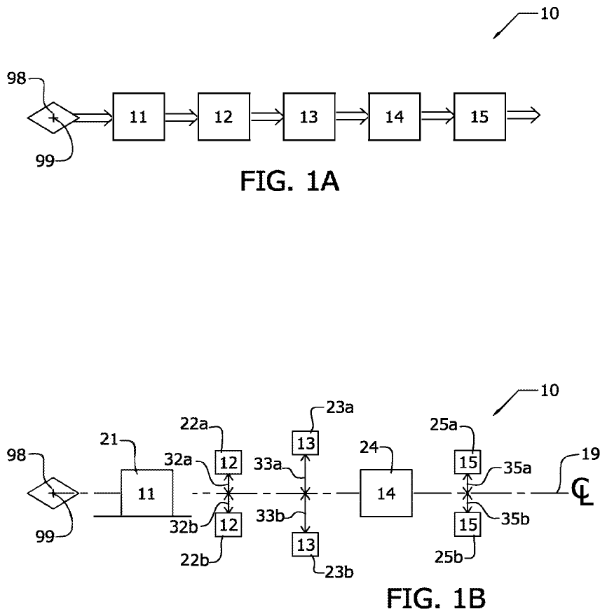

As illustrated in FIGS. 1A, 1B, exemplary dryer apparatus 10 includes stages 11, 12, 13, 14, 15, and vehicle 98 traverses consecutively through stages 11, 12, 13, 14, 15 of dryer apparatus 10 that dries vehicle 98 following washing of vehicle 98. Vehicle 98 may be, for example, a car, truck, or van, and dryer apparatus 10 may form a portion of a car wash facility. In this implementation, vehicle 98 is illustrated as traversing stages 11, 12, 13, 14, 15 with stages 11, 12, 13, 14, 15 and vehicle 98 moving for purposes of explanation. In various implementations, stage 14 may be similar to stage 11, and stage 15 may be similar to stage 12. Thus, some implementations may include stages 14, 15, and other implementations may omit stages 14, 15 as redundant. Yet other implementations may include an additional stage similar to stage 13. It should be understood that vehicle 98 may move with one or more of stages 11, 12, 13, 14, 15 being stationary, or one or more of stages 11, 12, 13, 14, 15 may move with vehicle 98 being stationary, in various other implementations.

As illustrated in FIG. 1B, stages 11 and 14 include blowers 21, 24 respectively. Stage 12 includes blowers 22a, 22b, stage 13 includes blowers 23a, 23b, and stage 15 includes blowers 25 a, 25b, as illustrated. Blowers 21, 24 are centered upon centerline 19 of dryer apparatus 10, in this implementation, and blowers 21, 24 may be of essentially the same configuration. Blowers 25a, 25b may be essentially of the same configuration as blowers 22a, 22b, respectively. Blowers 22a, 22b are offset from centerline 19 by lengths 32a, 32b normal to centerline 19, respectively, in this implementation. Blowers 23a, 23b are offset from centerline 19 by lengths 33a, 33b normal to centerline 19, respectively, in this implementation. Blowers 25a, 25b are offset from centerline 19 by lengths 35a, 35b normal to centerline 19, respectively, in this implementation. Lengths 32a, 32b may be generally the same, lengths 33a, 33b may be generally the same, and lengths 35a, 35b may be generally the same so that blowers 22a, 22b, blowers 23a, 23b, and blowers 25a, 25b are symmetrically located about centerline 19 of dryer apparatus 10, in this implementation.

As illustrated in FIG. 1B, center 99 of vehicle 98 follows centerline 19 as vehicle 98 is traversed through stages 11, 12, 13, 14, 15 of dryer apparatus 10. Accordingly, blowers 21, 24 are centered on center 99 of vehicle 98, blowers 22a, 22b are offset from center 99 of vehicle 98 by lengths 32a, 32b, respectively, blowers 23a, 23b are offset from center 99 of vehicle 98 by lengths 33a, 33b, respectively, and blowers 25a, 25b are offset from center 99 of vehicle 98 by lengths 35a, 35b, respectively, as vehicle 98 is traversed through stages 11, 12, 13, 14, 15 of dryer apparatus 10, in this implementation. Lengths 32a, 32b, 33a, 33b, 35a, 35b may be adjustable to position blowers 22a, 22b, 23a, 23b, 25a, 25b with respect to centerline 19 in order to accommodate a particular vehicle 98, and blowers 22a, 22b, 23a, 23b, 25a, 25b may be movably positioned as vehicle 98 is traversed through dryer apparatus 10.

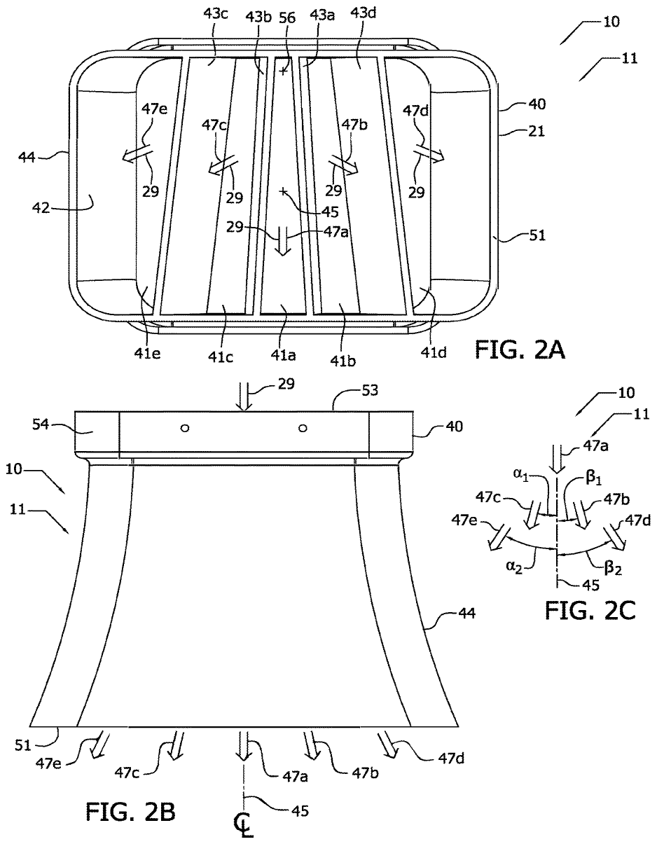

As illustrated in FIG. 2A, blower 21 of stage 11 of dryer apparatus 10 includes nozzle 40, and nozzle 40 is partitioned into apertures 41a, 41b, 41c, 41d, 41e defined by vanes 43a, 43b, 43c, 43d in combination with inner surface 42 of nozzle 40. Aperture 41a is centered and apertures 41b, 41c, 41d, 41e are disposed to the sides of aperture 41a, as illustrated. Nozzle 40 cooperates fluidly with one or more fans including compressors (not shown) that communicate air 29 into nozzle 40 at nozzle end 53 that then emanates forth as jets 47a, 47b, 47c, 47d, 47e from apertures 41a, 41b, 41c, 41d, 41e at nozzle end 51 of nozzle 40, respectively, as illustrated in FIGS. 2A, 2B. Air 29 that forms jets 47a, 47b, 47c, 47d, 47e may be heated, in some implementations, or ambient air generally at ambient temperature, in other implementations. FIG. 2B illustrates nozzle 40 including outer surface 44 and jets 47a, 47b, 47c, 47d, 47e emanating from nozzle end 51. Nozzle 40 may be securable to ductwork (not shown) that communicates air 29 into nozzle 40 at nozzle end 53 by collar 54, as illustrated in FIG. 2B. Fluid cooperation between nozzle end 53 of nozzle 40 and the one or more fans including, for example, ductwork, plenum(s), connectors, heater(s), controls, and electrical power, as well as the configuration of the one or more fans may be implemented in various ways readily recognizable by those of ordinary skill in the art upon study of this disclosure.

As illustrated in FIG. 2C, jets 47a, 47b, 47c, 47d, 47e emanate from nozzle 40 with jet 47a aligned with nozzle centerline 45 and jets 47c, 47e forming angles α₁, α₂, respectively, with nozzle centerline 45, where α₁<α₂. Jets 47b, 47d form angles B₁, B₂, respectively, with nozzle centerline 45, where B₁ <B₂. Also, jets 47b, 47c and jets 47d, 47e are symmetrical about nozzle centerline 45 with α₁≈B₁ and α₂≈B₂, as illustrated.

The area of aperture 4 la is less than the area of aperture 41c that, in turn, is less than the area of aperture 41e, as illustrated in FIG. 2A. Note that the area of aperture 41b is approximately equal to the area of aperture 41c, and the area of aperture 41d is approximately equal to the area of aperture 41e, as illustrated. Accordingly, the velocity of jet 47a is generally greater than the velocity of jet 47c that, in turn is greater than the velocity of jet 47e, in this implementation. The velocity of jet 47b is approximately equal to the velocity of jet 47c, and the velocity of jet 47d is approximately equal to the velocity of jet 47e, in this implementation. Aperture 41a, in this implementation, is tapered generally in a V-shape as illustrated with smallest cross-section and, thus, greatest jet velocity of jet 47a occurring at location 56.

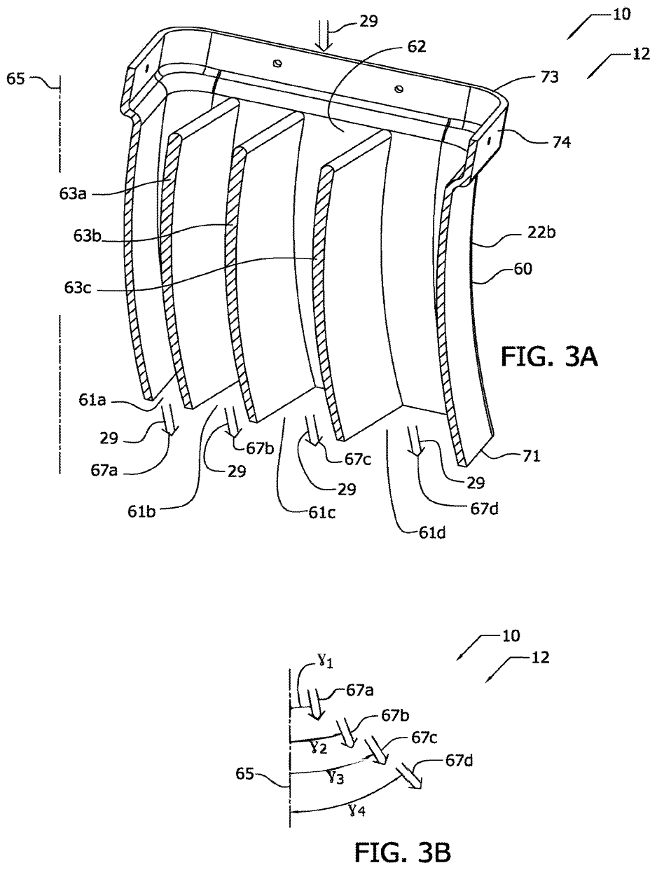

FIG. 3A illustrates nozzle 60 of blower 22b. Blowers 22a, 22b form stage 12 of dryer apparatus 10, and it should be noted that blower 22a is of similar construction to that of blower 22b but of opposite orientation. Air 29 enters nozzle end 73 of nozzle 60, and nozzle 60 may be connected by collar 74 to ductwork (not shown) that communicates air 29 into nozzle end 73 of nozzle 60. Nozzle 60 of blower 22b is partitioned into apertures 61a, 61b, 61c, 61d, by vanes 63a, 63b, 63c in cooperation with inner surface 62 of nozzle 60, as illustrated in FIG. 3A. As illustrated in FIG. 3A, jets 67a, 67b, 67c, 67d formed of air, such as air 29, emanate from nozzle 60 at nozzle end 71 through apertures 61a, 61b, 61c, 61d, respectively. As illustrated in FIG. 3B, jets 67a, 67b, 67c, 67d form angles y₁, y₂, y₃, y₄, respectively, with axis 65, where y₁<y₂<y₃<y₄ and axis 65 may be generally vertically oriented.

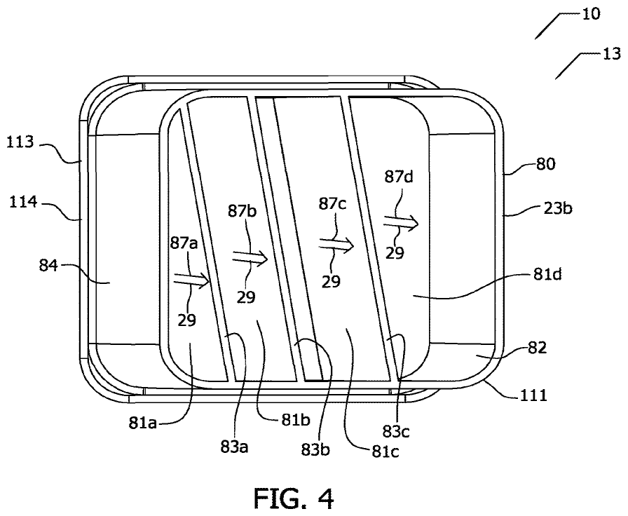

FIG. 4 illustrates nozzle 80 of blower 23b. Blowers 23a, 23b form stage 13 of dryer apparatus 10, and, it should be noted that blower 23a is of similar construction but opposite in orientation to blower 23b. Air 29 enters nozzle end 113 of nozzle 80, and nozzle 80 may be connected by collar 114 to ductwork (not shown) that communicates air 29 into nozzle end 113 of nozzle 80.

Nozzle 80 as illustrated in FIG. 4 includes outer surface 84 and inner surface 82. Nozzle 80 of blower 23b is partitioned into apertures 81a, 81b, 81c, 81d, by vanes 83a, 83b, 83c in cooperation with inner surface 82 of nozzle 80, as illustrated. Jets 87a, 87b, 87c, 87d formed of air 29 emanate from apertures 81a, 81b, 81c, 81d, respectively, at nozzle end 111 of nozzle 80, as illustrated.

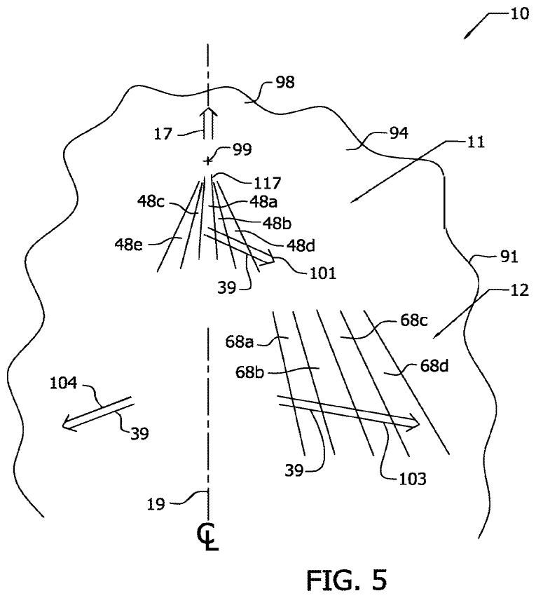

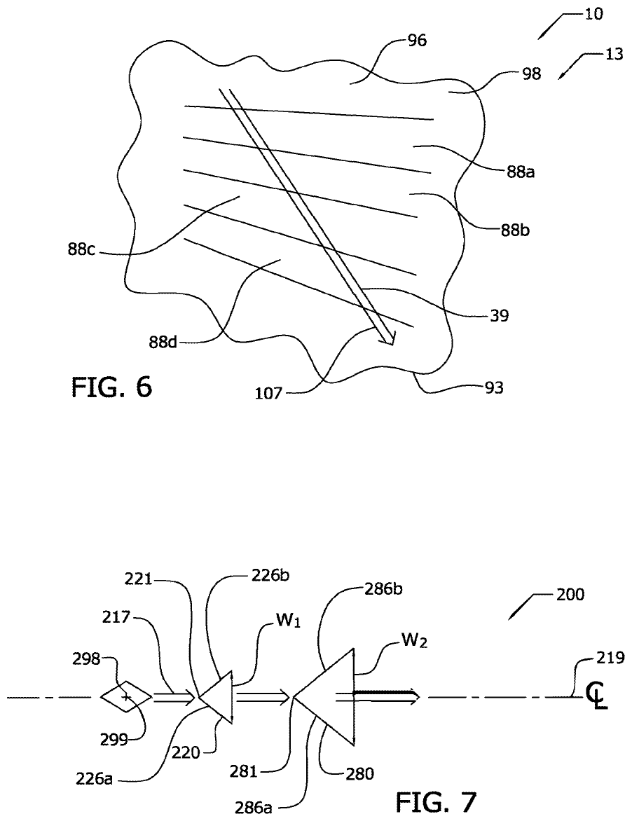

FIG. 5 illustrates the impact of jets 47a, 47b, 47c, 47d, 47e, 67a, 67b, 67c, 67d on upper surface 94 of vehicle 98 as vehicle 98 is traversed through stages 11, 12 of dryer apparatus 10 in the direction indicated by arrow 17. Upper surface 94 may include a roof, hood, trunk lid, cargo bed, window(s), and other generally horizontally oriented surfaces of vehicle 98, and nozzle centerline 45 of nozzle 40 and axis 65 of nozzle 60 may be generally normal to upper surface 94. As vehicle 98 traverses stage 11, jets 47a, 47b, 47c, 47d, 47e impact regions 48a, 48b, 48c, 48d, 48e, respectively, and as vehicle 98 traverses stage 12 following the traversal of stage 11, jets 67a, 67b, 67c, 67d impact regions 68a, 68b, 68c, 68d, respectively, as illustrated in FIG. 5. Thus, jets 47a, 47b, 47c, 47d, 47e and jets 67a, 67b, 67c, 67d are applied sequentially, not simultaneously, to vehicle 98 with jets 67a, 67b, 67c, 67d being applied after application of jets 47a, 47b, 47c, 47d, 47e. Regions 48a, 48b, 48d are arranged in staggered array (e.g., in echelon) successively offset from centerline 19, as illustrated, and regions 68a, 68b, 68c, 68d are in staggered array successively offset from centerline 19 and region 48d. Note that the portion of jet 47a emanating from portions of aperture 41a proximate location 56 impact region 48a proximate apex 117, so that portions of region 48a proximate apex 117 are impacted by the maximum velocity of jet 47a. The jet velocities of jets 47a, 47b, 47d, 67a, 67b, 67c, 67d may generally successively decrease. Thus, jets 47a, 47b, 47d, 67a, 67b, 67c, 67d impact regions 48a, 48b, 48d, 68a, 68b, 68c, 68d in succession to remove water 39 from regions 48a, 48b, 48d, 68a, 68b, 68c, 68d of upper surface 94 generally in the direction indicated by arrows 101, 103 toward boundary 91 of upper surface 94 thereby drying regions 48a, 48b, 48d, 68a, 68b, 68c, 68d of upper surface 94 of vehicle 98. Boundary 91 is generally the juncture of upper surface 94 with side surface 96 (see FIG. 6) of vehicle 98, in this implementation. Side surface 96 may include quarter panel(s), door(s), side panels, side windows, vehicle sides, and other generally vertically oriented surfaces of vehicle 98. Vanes 43a, 43b, 43d are configured to orient jets 47a, 47b, 47d to remove water 39 from upper surface 94 in the direction indicated by arrow 101, and vanes 63a, 63b, 63c are configured to orient jets 67a, 67b, 67c, 67d to remove water 39 from upper surface 94 in the direction indicated by arrow 103. Water 39 may pass over boundary 91 onto side surface 96.

Note that blower 23a mirrors blower 23b, in this implementation, and, thus, jets 47a, 47c, 47e in combination with jets similar to jets 67a, 67b, 67c, 67d from blower 23a remove water 39 successively from upper surface 94 in the direction indicated by arrow 104. Water 39 swept in the direction indicated by arrow 104 may pass over boundary 91 from upper surface 94 onto side surface 96. Note that the portion of jet 47a emanating from portions of aperture 41a proximate location 56 impact region 48a proximate apex 117, so that portions of region 48a proximate apex 117 are impacted by the maximum velocity of jet 47a initially as vehicle 98 is traversed through dryer apparatus 10. The jet velocities may generally successively decrease in order jet 47a>jet 47b>jet 47d>jet 67a>jet 67b>jet 67c>jet 67d.

FIG. 6 illustrates the impact of jets 87a, 87b, 87c, 87d of nozzle 80 of blower 23b on side surface 96 of vehicle 98 as vehicle 98 is traversed through stage 13 of dryer apparatus 10. As vehicle 98 traverses stage 13, jets 87a, 87b, 87c, 87d impact regions 88a, 88b, 88c, 88d, and regions 88a, 88b, 88c, 88d are in staggered array successively lower and rearward on side surface 96, as illustrated in FIG. 6. Thus, jets 87a, 87b, 87c, 87d remove water 39 successively from regions 88a, 88b, 88c, 88d of side surface 96 generally in the direction indicated by arrow 107 toward lower boundary 93 of side surface 96 thereby drying regions 88a, 88b, 88c, 88d of side surface 96 of vehicle 98. Vanes 83a, 83b, 83c are configured to orient jets 87a, 87b, 87c, 87d to remove water 39 from side surface 96 in the direction indicated by arrow 107, and water may be drawn in the direction indicated by arrow 107 by a combination of gravity and jets 87a, 87b, 87c, 87d. The jet velocities may generally successively decrease in order jet 87a >jet 87b >jet 87c >jet 87d. Note that jets 87a, 87b, 87c, 87d of nozzle 80 are applied sequentially to vehicle 98 after application of jets 67a, 67b, 67c, 67d. Water is thus removed sequentially from vehicle 98, for example, first from regions 48a, 48b, 48c, 48d, 48e of upper surface 94, then from regions 68a, 68b, 68c, 68d of upper surface 94, and then from side surface 96.

As illustrated in FIG. 7, vehicle 298 traverses through exemplary dryer apparatus 200 as indicated by arrow 217. Exemplary dryer apparatus 200 includes nozzle 220 having V-shaped configurations having width W 1 between the arms 226a, 226b of the “V” and nozzle 280 having width W₂ between the arms 286a, 286b of the “V” with W₂ being greater than W₁. Arms 226a, 226b of nozzle 220 and arms 286a, 286b of nozzle 280 are positioned symmetrically about centerline 219. Nozzles 220, 280 are set in spaced arrangement with respect to one another, in this implementation, so that vehicle 298 is traversed sequentially first past nozzle 220 and then past nozzle 280. As illustrated in FIG. 7, center 299 of vehicle 298 follows centerline 219 as vehicle 298 is traversed past nozzles 220, 280 of dryer apparatus 200. Accordingly, apexes 221, 281 of nozzles 220, 280, respectively, are centered on center 299 of vehicle 298 as vehicle 298 is traversed past nozzles 220, 280, in this implementation, to remove water, such as water 39, sequentially from surfaces, such as upper surface 94 first from width W₁ of the surface and then from width W₂ of the surface. Nozzles 220, 280 including widths W₁, W₂ may be adjustable, for example, in order to accommodate a particular vehicle 298.

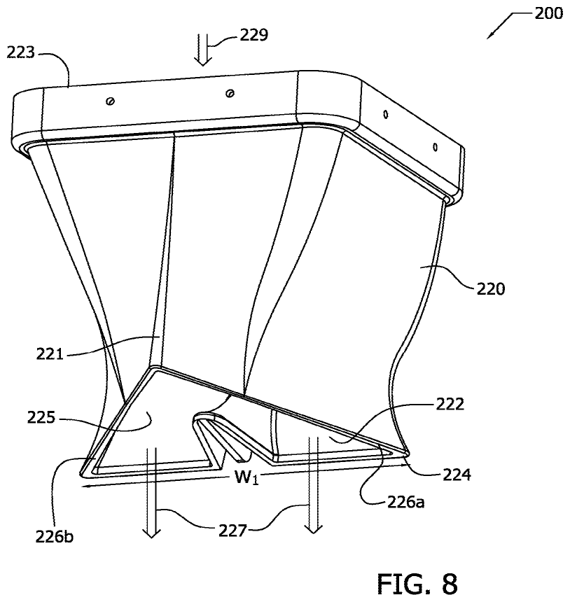

FIG. 8 illustrates nozzle 220 of dryer apparatus 200 with aperture 225 at nozzle end 224 formed in a symmetrical V-shape with width W₁ between arms 226a, 226b. Note that aperture 225 is a single aperture forming the symmetrical V-shape. Nozzle 280 of dryer apparatus 200 has width W₂ and is otherwise formed generally similarly to nozzle 220, in various implementations. As illustrated in FIG. 8, inner surface 222 of nozzle 220 is tapered from nozzle end 223 toward nozzle end 224 to accelerate air 229 input into nozzle end 223 into jet 227 that emanates forth from nozzle end 224 of nozzle 220 in generally a V-shaped configuration. Nozzle 220 cooperates fluidly with one or more fans (not shown) that communicate air 229 into nozzle 220 at nozzle end 223.

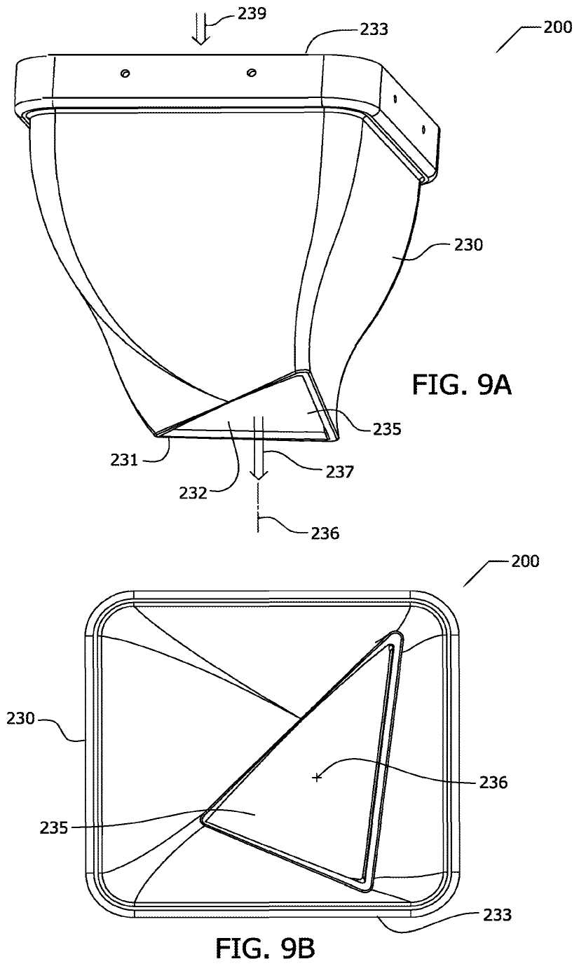

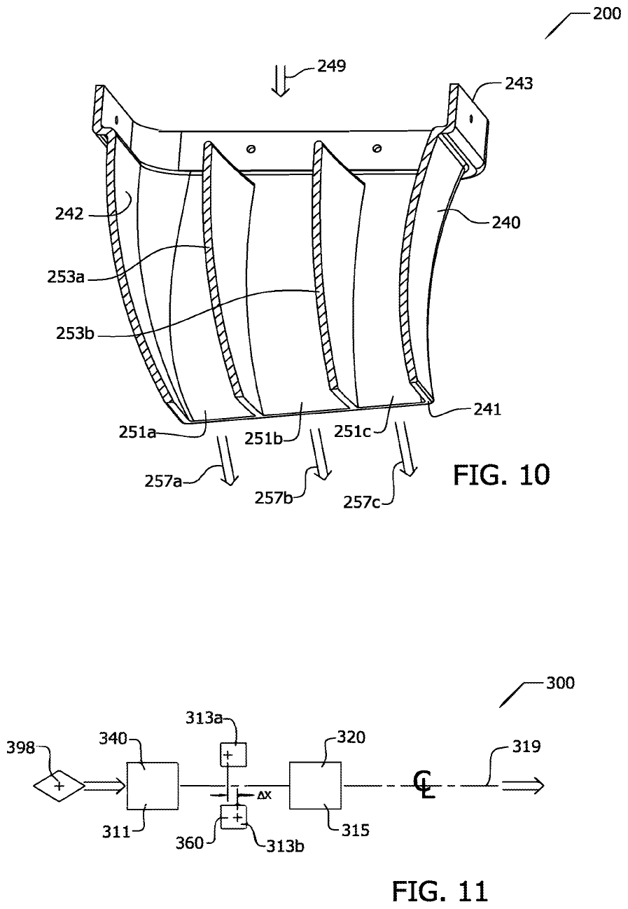

Although not illustrated in FIG. 7, various implementations of dryer apparatus 200 May 4, 2026 include additional nozzle(s) such as nozzle 230 illustrated in FIGS. 9A, 9B and nozzle 240 illustrated in FIG. 10. Nozzles 230, 240 may have various positions with respect to nozzles 220, 280, and additional nozzles that mirror nozzles 230, 240 may be included in various other implementations of dryer apparatus 200.

FIGS. 9A, 9B illustrate nozzle 230 of certain implementations of dryer apparatus 200 with aperture 235 formed in a triangular shape. In this implementation, aperture 235 has the shape of an isosceles triangle, but aperture 235 may have other triangular or even other polygonal shapes in other implementations. Inner surface 232 of nozzle 230 is tapered from nozzle end 233 toward nozzle end 231 to accelerate air 239 input into nozzle end 233 into jet 237 emanating forth from nozzle end 231 of nozzle 230.

As illustrated in FIG. 9B, nozzle 230 including inner surface 232 is shaped so that the shape of nozzle 230 in combination with the triangular shape of aperture 235 at nozzle end 231 imparts rotation to air 239 so that jet 237 has both linear velocity along axis 236 as well as rotation normal to axis 236. In certain implementations of dryer apparatus 200 that include nozzle 230, axis 236 may be oriented generally normal to a portion of vehicle 298 such as a window so that the rotation of jet 23 7 in combination with the linear velocity of jet 23 7 removes water, such as water 39, from this portion of vehicle 298. Certain implementations of dryer apparatus 200 may include nozzle 230 and a corresponding nozzle (not shown) formed as a mirror image of nozzle 230 with nozzle 230 and the mirror image nozzle of nozzle 230 offset symmetrically from centerline 219.

FIG. 10 illustrates nozzle 240 of certain implementations of dryer apparatus 200. Nozzle 240 is partitioned into apertures 251a, 251b, 251c at nozzle end 241 by vanes 253a, 253b in cooperation with inner surface 242 of nozzle 240, as illustrated in FIG. 10. As illustrated in FIG. 10, air 249 input into nozzle end 243 is trained by vanes 253a, 253b in cooperation with inner surface 242 emanates as jets 257a, 257b, 257c from nozzle 240 at nozzle end 241 through apertures 251a, 251b, 251c, respectively. Note that vanes 253a, 253b and inner surface 242 are curved, in this implementation, so that jets 257a, 257b, 257c have both radial and angular velocity components. Certain implementations of dryer apparatus 200 may include nozzle 240 and a corresponding nozzle (not shown) formed as a mirror image of nozzle 240 with nozzle 240 and the mirror image nozzle of nozzle 240 offset symmetrically from centerline 219.

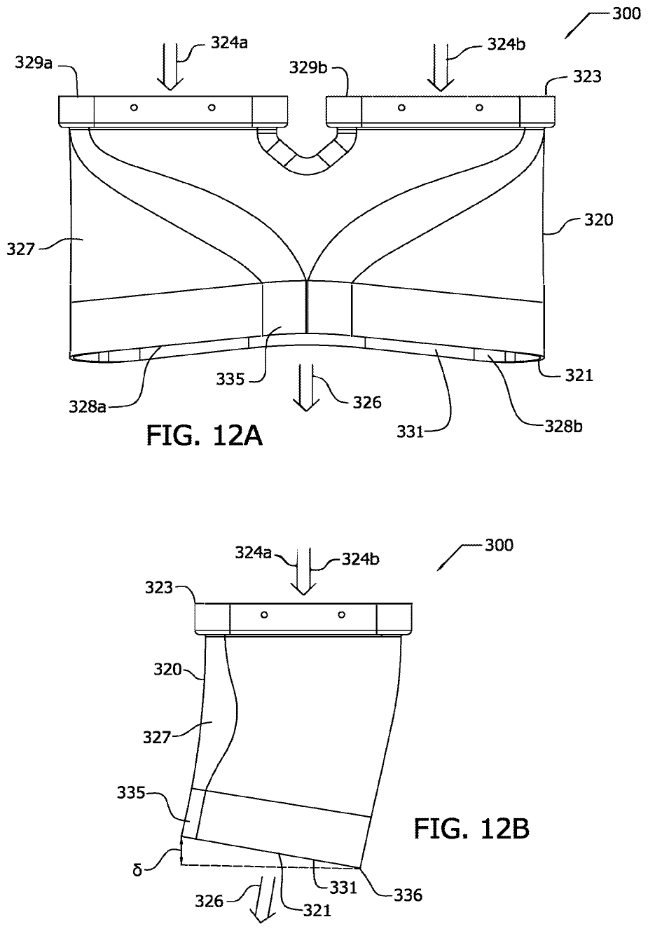

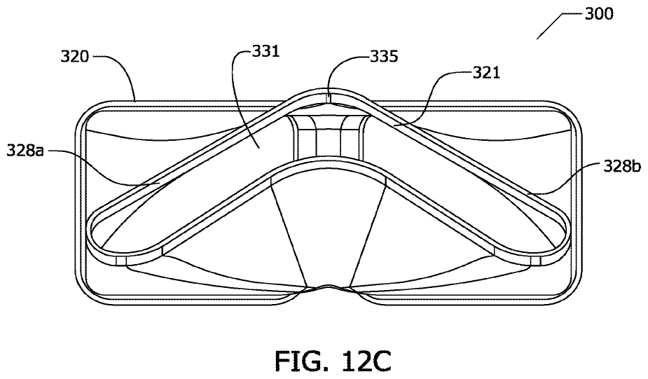

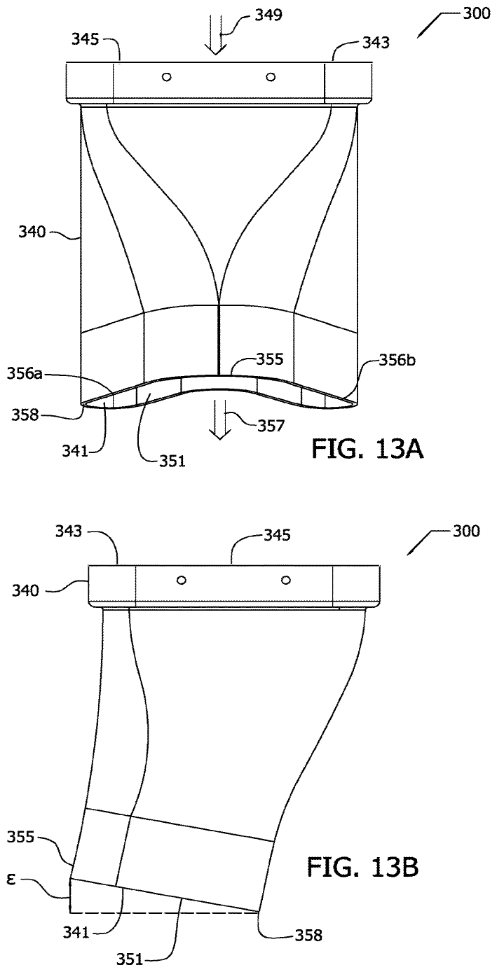

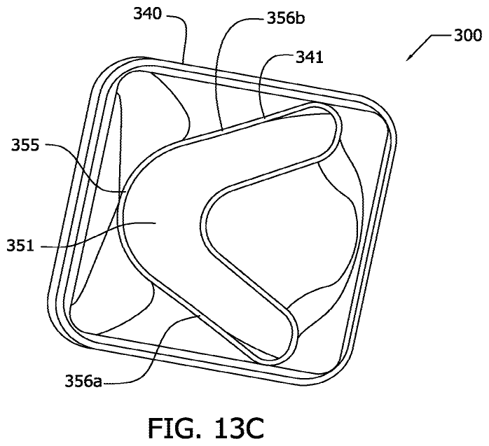

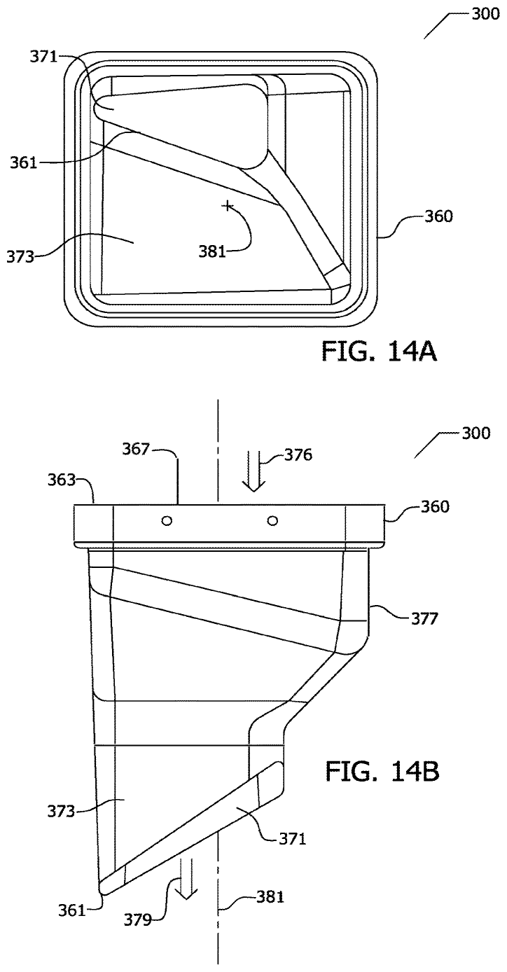

FIG. 11 illustrates exemplary dryer apparatus 300. As illustrated in FIG. 11, vehicle 398 passes along centerline 319 through stages 311, 313a, 313b, 315. Stage 311 includes nozzle 340 (see FIGS. 13A, 13B), stages 313a, 313b include nozzle 360 and a mirror image nozzle thereof (see FIGS. 14A, 14B), and stage 315 includes nozzle 320 (see FIGS. 12A, 12B), in this implementation. Stages 313a, 313b are located at the same position along centerline 319 and are offset from centerline 319 so that jets, such as jet 379, may simultaneously impact at least portions of an upper surface, such as upper surface 94, and at least portions of a side surface, such as side surface 96, of vehicle 398. Exemplary dryer apparatus 300 primarily removes water from the upper surface of vehicle 398. In other implementations, dryer apparatus 300 may include additional nozzles, such as nozzle 240 of dryer apparatus 200, and dryer apparatus 300 may include additional stages, for example, to remove water from side surface(s), such as side surface 96, of vehicle 398.

FIGS. 12A, 12B, 12C illustrate nozzle 320 of dryer apparatus 300 with aperture 331 at nozzle end 321 formed in a symmetrical V-shape with apex 335. As illustrated in FIG. 12A, air 324a, 324b is communicated into nozzle 320 through entries 329a, 329b, respectively, at nozzle end 323, and air 324a, 324b mixes and accelerates within nozzle 320 to emanate forth from aperture 331 at nozzle end 321 as jet 326 that generally has a V-shaped configuration in conformance to the V-shape of aperture 331. Entries 329a, 329b may have a cross-sectional area of 252 sq. inches and aperture 331 may have a cross-sectional area of 62 sq. inches, in certain implementations. Entries 329a, 329b may fluidly communicate with separate fans (not shown), in certain implementations. Side 327 that forms nozzle 320 converges, as illustrated, in order to accelerate air 324a, 324b into jet 326. As illustrated in FIG. 12B, apex 335 of the V-shape is offset from the position of base 336 of the V-shape to form angle δ, which may be, for example, about 10° in certain implementations.

Apex 335 may be aligned with centerline 319 and arms 328a, 328b may extend symmetrically about centerline 319 as vehicle 398 is traversed through stage 315, so that jet 326 impacts an upper surface, such as at least portions of upper surface 94, to remove water in a V pattern from the upper surface toward side surfaces, such as side surface 96, of vehicle 398. In various implementations, the V pattern may be about 72 inches wide.

FIGS. 13A, 13B, 13C illustrate nozzle 340 of dryer apparatus 300 with aperture 351 at nozzle end 341 formed in a symmetrical V-shape with apex 355 and arms 356a, 356b. As illustrated in FIG. 13A, air 349 is communicated into nozzle 340 through entry 345 at nozzle end 343, and air 349 accelerates within nozzle 340 to emanate forth from aperture 351 at nozzle end 341 as jet 357 that has a generally V-shaped configuration in conformance to V-shaped aperture 3 51. Entry 345 may have a cross-sectional area of about 126 sq. inches, and aperture 351 may have a cross-sectional area of about 30 sq. inches, in various implementations. As illustrated in FIG. 13B, apex 355 of the V-shape is offset from the position of base 358 of the V-shape to form angle ε, which may be, for example, about 11° in certain implementations. As illustrated, aperture 351 at nozzle end 341 is positioned eccentrically with respect to entry 345 at nozzle end 343, which may induce rotation in jet 357.

Apex 355 may be aligned with centerline 319 and arms 356a, 356b extend symmetrically with respect to centerline 319 as the vehicle 398 is traversed through stage 311, so that V-shaped jet 357 impacts an upper surface, such as at least portions of upper surface 94, to remove water in a V pattern from the upper surface toward side surfaces, such as side surface 96, of vehicle 398. In various implementations, the V pattern may be about 36 inches wide.

FIGS. 14A, 14B illustrate nozzle 360 of dryer apparatus 300 with aperture 371 at nozzle end 361 formed in a triangular shape. Nozzle 360 is used at stage 313b of dryer apparatus 300, in this implementation. As illustrated in FIG. 14B, air 376 is communicated into nozzle 360 through entry 367 at nozzle end 363, and air 376 accelerates within nozzle 360 to emanate forth from aperture 371 at nozzle end 361 as jet 379. Entry 367 may be about 126 sq. inches in cross-sectional area, and aperture 371 may have a cross-sectional area of about 26 sq. inches, in various implementations. As illustrated, axis 381 is centered in entry 367 and passes through nozzle 360 between nozzle ends 361, 363. Aperture 371 at nozzle end 361 is positioned eccentrically with respect to axis 381, as illustrated, and aperture 371 is angled with respect to axis 381. The angling of aperture 371 with respect to axis 381 in combination with the eccentric placement of aperture 3 71 with respect to axis 3 81 may introduce rotation into jet 3 79 that may facilitate drying. Portions of side 373 that form nozzle 360 are curved toward aperture 371 to accelerate air 376 as jet 379, as illustrated in FIG. 14B, which may introduce rotation into jet 379.

Aperture 371 may have various alignments with respect to vehicle 398, and aperture 371 may be aligned such that jet 379 simultaneously impacts at least portions of an upper surface, such as upper surface 94, and at least portions of a side surface, such as of side surface 96, of vehicle 398. Jet 379 may impact the upper surface starting approximately at the edge of the V pattern from nozzle 340 to sweep water from the upper surface toward the side surface, and jet 379 may impact the side surface to sweep water on the side surface vertically downward.

Aperture 371 may be angled downward and outward from the side surface, as illustrated. As illustrated in FIGS. 14A, 14B, nozzle 360 is positioned at stage 313b that is on the right side (U.S. vehicle passenger side) of vehicle 398 with side 377 closest to centerline 319. A mirror image (not shown) of exemplary nozzle 360 is positioned at stage 313a on left side (U.S. vehicle driver side) of vehicle 398. As illustrated in FIG. 11, the jets at stages 313a, 313b are offset from one another along centerline 319 by length ~x to prevent interaction between stages 313a, 313b, for example, to prevent interaction between jet 379 at stage 313b and the jet from the mirror image nozzle at stage 313a. Length Δx may be about 8 inches, in certain implementations.

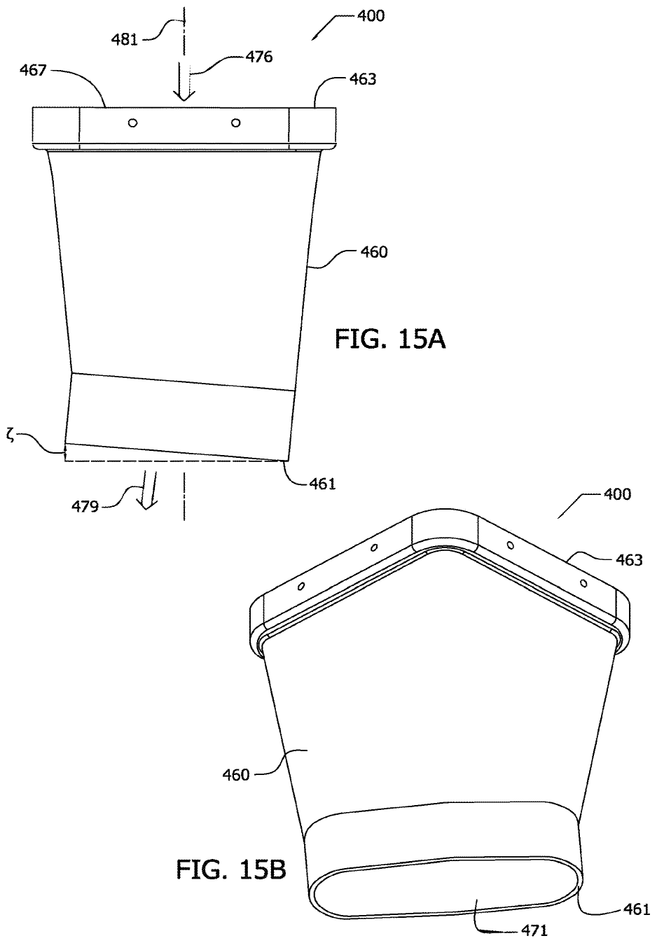

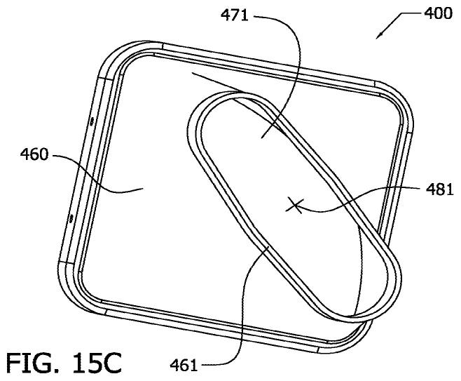

FIGS. 15A, 15B, 15C illustrate nozzle 460 of exemplary dryer apparatus 400 with aperture 471 at nozzle end 461 formed in an elongated oblong shape. Nozzle 460, for example, may be used in substitution for nozzle 360 at stage 313b of dryer apparatus 300, or in substitution for nozzle 230 of dryer apparatus 200. As illustrated in FIG. 15A, air 476 is communicated into nozzle 460 through entry 467 at nozzle end 463, and the shape of nozzle 460 accelerates air 476 within nozzle 460 to emanate forth from aperture 471 at nozzle end 461 as jet 479. Nozzle end 461 is angled at angle ζ with respect to axis 481 to angle aperture 471 accordingly. Angle ζ may be about 5°, in certain implementations. The shape of nozzle 460 along with the placement of aperture 471 may introduce rotation into jet 479 that may facilitate drying of portions of a vehicle, such as vehicle 98, 298, 398, impacted by jet 479. Axis 481 and, thus, jet 479 may have various alignments with respect to a vehicle, such as vehicle 98, 298, 398, and aperture 4 71 may be aligned such that jet 479 impacts at least portions of an upper surface, such as upper surface 94, at least portions of a side surface, such as of side surface 96, or both the upper surface and the side surface of the vehicle.

In operation of a dryer apparatus, such as dryer apparatus 10, 200, 300, 400, a vehicle, such as vehicle 98, 298, 398, may traverse in sequence through multiple stages, such as stages 11, 12, 13, 14, 15, 311, 313a, 313b, 315, of the dryer apparatus. The vehicle may be wet from washing as the vehicle enters the stages of the dryer apparatus, and the stages may be arranged to sequentially remove water, such as water 39, from the vehicle. For example, as the vehicle traverses one or more of the stages, jets, such as jets 47a, 47b, 47c, 47d, 47e, 67a, 67b, 67c, 67d, 227, 237, 326, 357, 379, 479, impact regions of an upper surface of the vehicle, such as regions 48a, 48b, 48c, 48d, 48e, 68a, 68b, 68c, 68d of upper surface 94. The regions may be arranged in echelon with respect to a centerline, such as centerline 19, 219, 319, along which the vehicle is centered as the vehicle is traversed through the stages. The regions may be distinct with each jet directed toward a distinct region, although there may be some overlap. The stages may be arranged so that the jets at each stage impact the vehicle sequentially not simultaneously. Thus, the jets remove water successively from the regions of the upper surface thereby drying the upper surface sequentially first one portion of the upper surface is dried followed by drying of another portion of the upper surface. The jets may remove water from the upper surface by evaporation, by forcing the water off of the upper surface at least in part toward the side surface(s), or combinations thereof.

Following removing of water from the upper surface, water forced onto a side surface, such as side surface 96, of the vehicle from the upper surface as well as water otherwise accumulated on the side surface is then removed as the vehicle traverses one or more stages, in various implementations. Jets, such as jets 87a, 87b, 87c, 87d, 257a, 257b, 257c, 379, 479, impact side surface(s) in regions, such as regions 88a, 88b, 88c, 88d, that may be arranged in echelon successively lower and rearward on the side surface thereby removing water from the side surface as the vehicle is traversed through the dryer apparatus. The jets may remove water from the side surface by evaporation, by forcing the water off of the side surface(s), or combinations thereof.

Lengths, such as lengths 32a, 32b, 33a, 33b, 35a, 35b, at which blowers, such as blowers 22a, 22b, 23a, 23b, 25a, 25b, are offset from the centerline, such as centerline 19, 219, and the lengths may be adjusted during operation according to the type (e.g., size) of the vehicle in order that the jets properly impact the upper surface and the side surface of the vehicle. Certain nozzles may be offset from the centerline, and the nozzles including the height or position with respect to the centerline may be adjusted during operation to accommodate a particular size or type of vehicle.

In various implementations, the stages may be repeated, for example, to remove the water from the upper surface, to remove the water from the side surface, or to both remove water from the upper surface and from the side surface. The various dryer apparatus described herein including the stages, the sequence of stages, as well as the nozzle(s), such as nozzles 40, 60, 80, 220, 230, 240, 280, 320, 340, 360, 460, utilized in a particular stage are exemplary. In various other implementations, the particular stage may include various other nozzle(s) or combinations of nozzles, and the stages may be sequenced in various other ways. The drying apparatus may expose the vehicle to various nozzles or combinations of nozzles as the vehicle passes through the drying apparatus, in various other implementations. The various nozzles or combinations of nozzles may be traversed about the vehicle, in various other implementations. The stages are illustrated herein as arranged in a linear fashion for explanatory purposes. It should be understood that other arrangements such as a curved, angled, or serpentine arrangement of the stages may be utilized, in other implementations. Stages may be combined in certain implementations, for example, to remove water from upper surface(s) and from side surface(s) generally simultaneously, in various implementations.

The foregoing discussion along with the Figures discloses and describes various exemplary implementations. These implementations are not meant to limit the scope of coverage, but, instead, to assist in understanding the context of the language used in this specification and in the claims. The Abstract is presented to meet requirements of 37 C.F.R. § 1.72(b) only. The Abstract is not intended to identify key elements of the apparatus and methods disclosed herein or to delineate the scope thereof. Upon study of this disclosure and the exemplary implementations herein, one of ordinary skill in the art may readily recognize that various changes, modifications and variations can be made thereto without departing from the spirit and scope of the inventions as defined in the following claims.

The invention claimed is:

1. A nozzle for a vehicle drying apparatus, comprising:
a nozzle body having a first nozzle end and a second nozzle end;
an inner surface extending between the first nozzle end and the second nozzle end, the inner surface tapered from the first nozzle end toward the second nozzle end; and
an aperture at the second nozzle end formed in a V-shape having a first arm and an opposing second arm extending from an apex, the aperture configured to emanate a jet of air in a V-shaped configuration.

2. The nozzle of claim 1, wherein the first nozzle end is adapted to couple to a fan or a blower by one or more of ductwork, plenums, or connectors.

3. The nozzle of claim 1, wherein the first arm and the second arm are disposed symmetrically about the apex.

4. The nozzle of claim 1, wherein the aperture is a single aperture forming the V-shape.

5. The nozzle of claim 1, further comprising:
a first entry and a second entry at the first nozzle end, each configured to receive air into the nozzle body, wherein air received through the first entry and the second entry mixes and accelerates within the nozzle body to emanate forth from the aperture as the jet.

6. The nozzle of claim 5, wherein the first entry and the second entry have a combined cross-sectional area greater than a cross-sectional area of the aperture.

7. The nozzle of claim 1, wherein a side of the nozzle body converges from the first nozzle end toward the second nozzle end to accelerate air into the jet.

8. The nozzle of claim 1, wherein the jet emanating from the aperture is configured to impact an external surface of a vehicle at an acute angle.

9. A nozzle for removing water from a surface of a vehicle, comprising:
a nozzle body having a first nozzle end and a second nozzle end;
an inner surface extending between the first nozzle end and the second nozzle end, the inner surface tapered from the first nozzle end toward the second nozzle end;
a first entry and a second entry at the first nozzle end configured to receive air into the nozzle body, wherein air received through the first entry and the second entry mixes and accelerates within the nozzle body to emanate forth from an aperture at the second nozzle end as a jet; and
the aperture formed in a V-shape having a first arm and an opposing second arm extending from an apex, the jet having a V-shaped configuration in conformance to the V-shape of the aperture.

10. The nozzle of claim 9, wherein the first entry and the second entry of the first nozzle end are each adapted to couple to a fan or a blower by one or more of ductwork, plenums, or connectors.

11. The nozzle of claim 9, wherein the first entry and the second entry have a combined cross-sectional area greater than a cross-sectional area of the aperture.

12. The nozzle of claim 9, wherein the jet is configured to impact an external surface of the vehicle to remove water in a V pattern from the external surface toward side surfaces of the vehicle.

13. The nozzle of claim 9, wherein the first arm and the second arm are disposed symmetrically about the apex.

14. The nozzle of claim 9, wherein a side of the nozzle body converges from the first nozzle end toward the second nozzle end to accelerate air into the jet.

15. The nozzle of claim 9, wherein the jet emanating from the aperture is configured to impact an external surface of a vehicle at an acute angle.

16. A method of drying a vehicle, comprising:
impacting an external surface of the vehicle with a jet of air emanating from a nozzle, the nozzle comprising a nozzle body having a first nozzle end and a second nozzle end, an inner surface extending between the first nozzle end and the second nozzle end, the inner surface tapered from the first nozzle end toward the second nozzle end, and an aperture at the second nozzle end formed in a V-shape having a first arm and an opposing second arm extending from an apex, the jet having a V-shaped configuration in conformance to the V-shape of the aperture; and
forcing water on the external surface of the vehicle laterally toward sides of the vehicle by the jet impacting the external surface.

17. The method of claim 16, wherein the jet impacts the external surface at an acute angle.

18. The method of claim 16, further comprising traversing the vehicle through a drying apparatus comprising the nozzle.

19. The method of claim 18, wherein the drying apparatus forms a portion of a car wash facility.
